(19) United States
(12) Patent Application Publication
(10) Pub. No.: US 2005/0030681 A1
(43) Pub. Date: Feb. 10, 2005

(54) Source follower with rail-to-rail voltage swing

(75) Inventor: Bruce Rosenthal, Los Gatos, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Analog Microelectronics, Inc.

(21) Appl. No.: 10/636,143

(22) Filed: Aug. 6, 2003

(51) Int. Cl. H02H 3/20

(52) U.S. Cl. 361/18

(57) ABSTRACT

A source follower can include a primary driving device that is limited by its threshold voltage as well as a secondary driving device that is not limited by its threshold voltage, thereby allowing the secondary driving device to drive the output voltage fully to the desired voltage rail. This secondary driving device can be activated substantially at the same time the primary driving device is reaching its maximum voltage transfer, thereby ensuring a linear output voltage transfer. This source follower can be implemented in an amplifier. This amplifier, which can output true rail-to-rail voltages, can advantageously provide optimal performance, particularly in low power applications.

### BACKGROUND OF THE INVENTION

1. Field of the Invention

The present invention relates to a source follower that can provide a rail-to-rail voltage swing.

2. Discussion of the Related Art

In a conventional source follower, the output voltage of the source follower follows its input voltage up/down to a predetermined level. For example, FIG. 1 illustrates a source follower 100 comprising an n-channel transistor with its drain connected to a high voltage source VDD and its source coupled through a current source to a low voltage source VSS (e.g. ground).

In this configuration, if source follower 100 receives a low voltage on its gate terminal IN, then the n-channel transistor does not conduct, thereby allowing the voltage on the output terminal OUT to be pulled low by the current source. In contrast, if source follower 100 receives a high voltage on its gate terminal IN, then the n-channel transistor begins to conduct, thereby overcoming the current source and pulling the output terminal OUT high. Specifically, the voltage on output terminal OUT increases to VDD minus the threshold of the n-channel transistor. In one embodiment, the threshold could be 0.5 V. Thus, particularly for low voltage applications in the range of 2.0 to 3.0 V, performance could be significantly lessened by a source follower that is unable to attain the rail voltage of VDD. including a transistor 201, which serves as an initial pull-up device. In source follower 200, two inverters 202A and 202B buffer a signal provided on an input terminal IN. Transistor 201 is an n-channel transistor with its drain coupled to VDD, its body coupled to VSS, and its source coupled to an output terminal OUT. Therefore, the maximum voltage provided by transistor 201 on output terminal OUT is also VDD minus the threshold voltage of transistor 201. In contrast, inverters 202A/202B can provide a rail-to-rail voltage (i.e. either VDD or VSS).

However, transistor 201 receives the same input signal as inverters 202A/202B. Therefore, inverters 202A/202B provide their buffered VDD signal after some delay independent of when transistor 201 provides its maximum voltage transfer. Unfortunately, this configuration can result in non-linearity in the output signal. This non-linearity limits the usefulness of source follower 200 in linear or amplifying applications.

Note that, as shown in FIGS. 1 and 2, a source follower can attempt to pull its output voltage to the high voltage rail. However, other known source followers can attempt to pull their output voltages to the low voltage rail. Typical embodiments for source followers associated with the low voltage rail comprise p-channel transistors. Unfortunately, these p-channel transistors are generally balanced based on n-channel transistors provided on the same integrated circuit (IC). In other words, if n-channel transistors on the IC have a threshold of 0.5 V, then p-channel transistors on the same IC would be made to have a corresponding threshold of −0.5 V. Therefore, such p-channel transistors could pull down their output voltage to VSS−(−0.5)=0.5 V, wherein VSS is assumed to be 0.

Therefore, a need arises for a source follower that can pull its output voltage fully to the voltage rail. Moreover, a need arises for a source follower to provide such output voltage in a linear manner, thereby advantageously increasing the number and type of applications in which the source follower can be used.

### SUMMARY OF THE INVENTION

A source follower is a circuit that should output a signal substantially the same as its input signal. A conventional source follower can be implemented using a transistor and a current source. The gate of the transistor receives the input signal and the drain receives a voltage from a first voltage rail. When the transistor conducts, the source of the transistor should provide a voltage of the first voltage rail. When not conducting, the current source, which is connected to the source of the transistor, can drive the output voltage to a second voltage rail.

Therefore, to form an exemplary source follower, an n-channel transistor could have its drain connected to a high voltage rail. In this manner, a logic high input signal provided to the gate turns on the n-channel transistor and provides a high output signal on its source. Similarly, a p-channel transistor could have its drain connected to a low voltage rail. In this manner, a logic low input signal provided to the gate turns on the p-channel transistor and provides a low output signal on its source.

Unfortunately, in these configurations, the source followers cannot drive their output voltages fully to the first voltage rail. Specifically, in either configuration, the threshold voltage of the transistor is a limiting feature. Therefore, conventional source followers cannot provide optimal performance, particularly in low power applications.

In accordance with one feature of the present invention, a source follower can include a primary driving device that is limited by its threshold voltage as well as a secondary driving device that is not limited by its threshold voltage. In this manner, the secondary driving device can drive the output voltage fully to the desired voltage rail. Of importance, this secondary driving device can be activated substantially at the same time the primary driving device is reaching its maximum voltage transfer, thereby ensuring a linear voltage transfer.

In one embodiment, the source follower can include a first device having first conducting properties coupled to an input terminal as well as an output terminal of the source follower. The first device can also be coupled between a first voltage source and a second voltage source.

The source follower can further include a current source coupled to the second voltage source, the first device, and the output terminal. If the first device is not conducting, then the current source pulls a voltage on the output terminal to a voltage provided by the second voltage source. On the other hand, if the first device is conducting, then the first device pulls the voltage on the output terminal to a voltage provided by the first voltage source minus a threshold voltage of the first device.

Of importance, the source follower in accordance with the present invention further includes a second device having second conducting properties coupled between the output terminal and the first voltage source. This second device, which has second conducting properties different than the first conducting properties, can receive a different input signal than the first device. The second device, when conducting, pulls the voltage on the output terminal to the voltage provided by the first voltage source. In a preferred embodiment, the second device conducts only when the first device provides the voltage provided by the first voltage source minus a threshold voltage of the first device on the output terminal.

In one embodiment of a source follower, the first device includes a p-channel transistor and the second device includes an n-channel transistor. In this case, the first voltage source is a low voltage source and the second voltage source is a high voltage source. In another embodiment of a source follower, the first device includes an n-channel transistor and the second device includes a p-channel transistor. In this case, the first voltage source is a high voltage source and the second voltage source is a low voltage source. In yet another embodiment, the source follower can include a current limiting control circuit coupled to the first and second devices, wherein the current limiting control circuit disables the first and second devices when the source follower is subjected to abnormal operating conditions.

The rail-to-rail source follower can be implemented in an amplifier circuit. In one embodiment, the input signal to the second device can be generated by a portion of the amplifier circuit that senses when it is beginning to saturate. This saturation point corresponds to the point when the first device provides its maximum voltage transfer to the output terminal of the source follower. This amplifier circuit, which can output true rail-to-rail voltages, can advantageously provide optimal performance, particularly in low power applications.

In one embodiment, an amplifier circuit can include a folded cascode amplifier, an operational transconductance amplifier (OTA), and a source follower. The source follower includes a primary device and a secondary device. The primary device, which receives an output of the folded cascode amplifier, can drive an output voltage near a first voltage rail. The secondary device, which receives an output of the OTA, can drive the output voltage to the first voltage rail when the primary device reaches its limit. The amplifier circuit can further include a current source for driving the output voltage to a second voltage rail when the primary and secondary devices are not conducting.

### BRIEF DESCRIPTION OF THE FIGURES

FIG. 1 illustrates a conventional source follower that is unable to provide a rail-to-rail voltage.

FIG. 2 illustrates a known source follower able to provide a rail-to-rail voltage, but in a non-linear manner.

FIG. 3 illustrates a source follower capable of providing a rail-to-rail voltage in a linear manner.

FIG. 4 illustrates another source follower capable of providing a rail-to-rail voltage in a linear manner.

FIG. 5 illustrates a simplified amplifier circuit comprising a source follower that can provide a rail-to-rail voltage.

FIG. 6A-6C illustrates one embodiment of an amplifier circuit comprising a source follower that can provide a rail-to-rail voltage.

### DETAILED DESCRIPTION OF THE FIGURES

In accordance with one feature of the invention, a source follower includes a secondary driving device that can assist the primary driving device in providing a true rail-to-rail voltage. In this manner, the source follower can advantageously provide optimal performance, particularly in low power applications. Of importance, the secondary driving device provides its assistance based on when the maximum voltage transfer in the primary driving device occurs. Therefore, the output voltage transfer of the source follower is virtually linear, thereby further increasing the type of applications in which the source follower can be used.

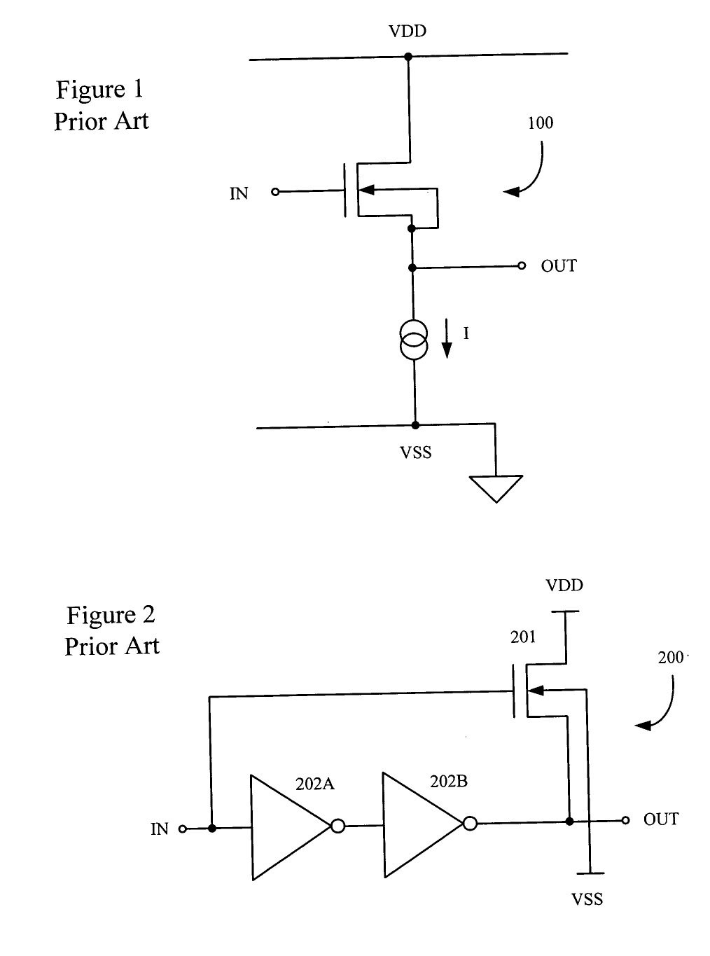

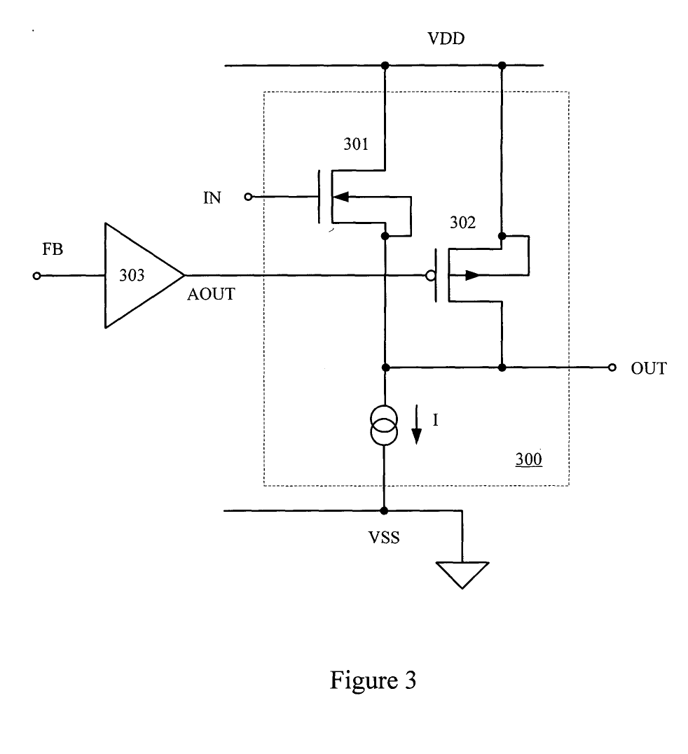

FIG. 3 illustrates one embodiment of a source follower 300 capable of pulling its output voltage fully to a high voltage rail. In this embodiment, source follower 300 includes an n-channel transistor 301 having its drain connected to high voltage source VDD, its source coupled via a current source to low voltage source VSS, and its gate connected the input terminal IN of source follower 300. In this configuration, n-channel transistor 301 functions similarly to the n-channel transistor in source follower 100 (FIG. 1).

Source follower 300 further includes a secondary path that can assist n-channel transistor 301 in pulling the voltage on output terminal OUT to VDD. In this embodiment, the secondary path includes a p-channel transistor 302 having its source connected to high voltage source VDD and its drain connected to output terminal OUT. An amplifier 303 receives a feedback signal FB and outputs a signal AOUT to the gate of p-channel transistor 302.

Of importance, signal AOUT changes state when amplifier 303 becomes saturated. Specifically, when amplifier 303 becomes saturated, signal AOUT switches to a logic 0, which turns on p-channel transistor 302. A p-channel transistor having its source connected to the high voltage source VDD is almost a perfect switch when conducting. In other words, the threshold of the p-channel transistor in this configuration is substantially zero. Thus, in this conducting state, p-channel transistor 302 can effectively pull up the voltage on output terminal OUT to VDD.

In accordance with one feature of the invention, the point at which amplifier 303 becomes saturated is substantially the same point that n-channel transistor 301 reaches its maximum pull-up voltage on output terminal OUT. In this manner, n-channel transistor 301 provides the initial pull up to VDD minus its threshold voltage and p-channel transistor 302 then supplements that pull up to ensure the voltage on output terminal OUT reaches VDD.

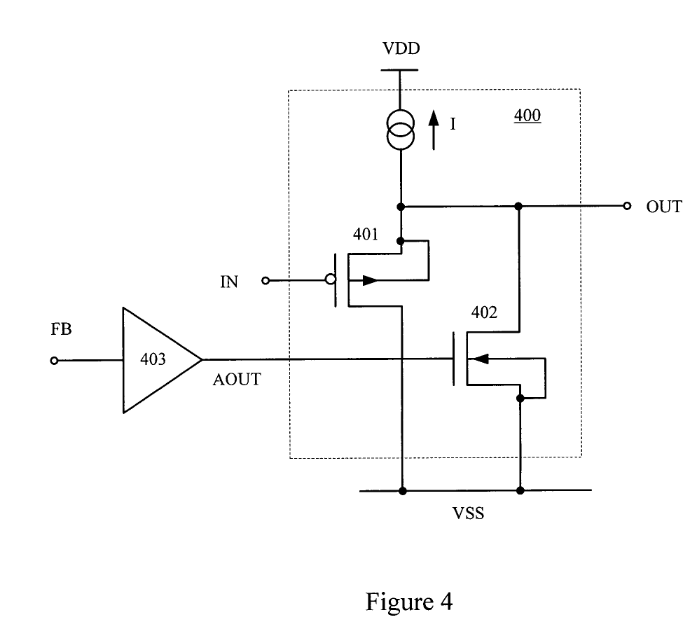

FIG. 4 illustrates one embodiment of a source follower 400 capable of pulling its output voltage fully to a low voltage rail. In this embodiment, source follower 400 includes a p-channel transistor 401 having its drain connected to low voltage source VSS, its source coupled via a current source to high voltage source VDD, and its gate connected to the input terminal IN of source follower 400. In this configuration, when conducting, p-channel transistor 401 can pull down the voltage on output terminal OUT to VSS minus its threshold voltage.

Source follower 400 further includes a secondary path that can assist p-channel transistor 401 in pulling the voltage on output terminal OUT down to VSS. In this embodiment, the secondary path includes an n-channel transistor 402 having its source connected to low voltage source VSS and its drain connected to output terminal OUT. An amplifier 403 receives a feedback signal FB and outputs a signal AOUT to the gate of n-channel transistor 402.

Of importance, signal AOUT changes state when amplifier 403 becomes saturated. Specifically, when amplifier 403 becomes saturated, signal AOUT switches to a logic 1, which turns on n-channel transistor 402. An n-channel transistor having its source connected to the low voltage source VSS is almost a perfect switch when conducting. In other words, the threshold of the n-channel transistor in this configuration is substantially zero. Thus, in this conducting state, n-channel transistor 402 can effectively pull down the voltage on output terminal OUT to VSS.

In accordance with one feature of the invention, the point at which amplifier 403 becomes saturated is substantially the same point that p-channel transistor 401 reaches its maximum pull-down voltage on output terminal OUT. In this manner, p-channel transistor 401 provides the initial pull down to VSS minus its threshold voltage and n-channel transistor 402 then supplements that pull down to ensure the voltage on output terminal OUT reaches VSS.

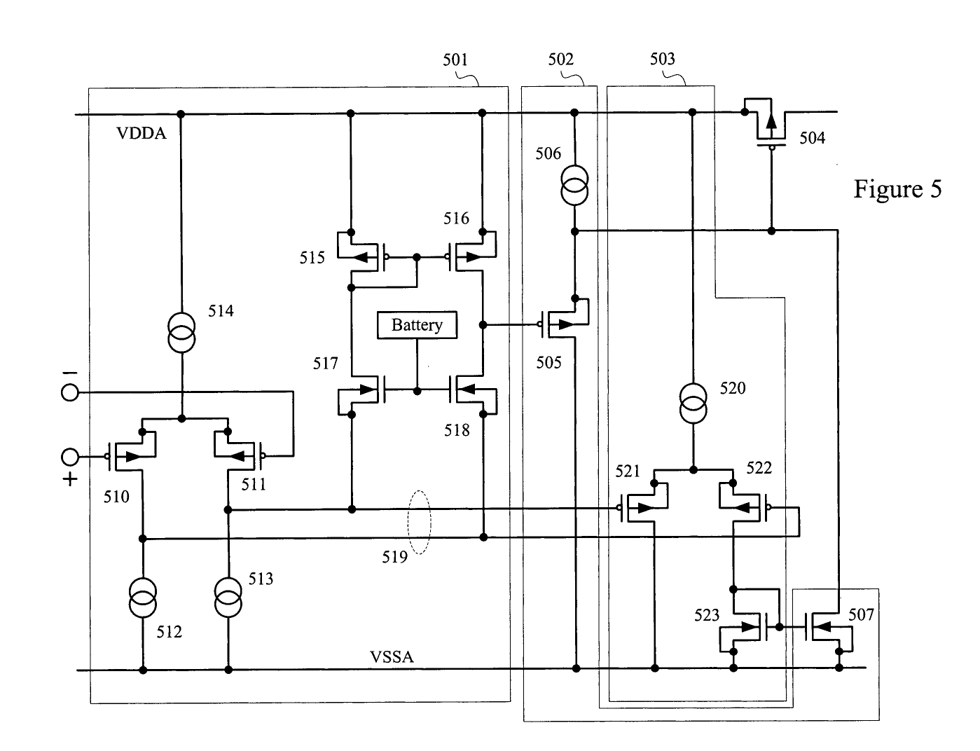

Note that although amplifiers 303 and 403 (FIGS. 3 and 4) are shown as separate elements from the source followers, in other embodiments, the source followers can be included as part of such amplifiers (discussed in reference to FIGS. 5A-5C).

Simplified Amplifier Circuit Embodiment

FIG. 5 illustrates one simplified embodiment of an amplifier circuit 500 in which an exemplary source follower able to provide rail-to-rail voltage can be incorporated. Amplifier circuit 500 includes a folded cascode amplifier 501, a source follower 502, an operational transconductance amplifier (OTA) 503, and an output device 504 that benefits from the rail-to-rail voltage. In this embodiment, source follower 502 includes a p-channel transistor 505 coupled between a current source 506 and voltage source VSSA and an n-channel transistor 507 coupled between an output of source follower 502 and voltage source VSSA.

Thus, referring also to FIG. 4, current source I, p-channel transistor 401, and n-channel transistor 402 can be implemented using current source 506, p-channel transistor 505, and n-channel transistor 507. Moreover, amplifier 403 can be implemented using OTA 503, which derives its input from folded cascode amplifier 501. Various embodiments of folded cascode amplifier 501 are described in U.S. patent application Ser. No. 10/621,747, entitled “Folded Cascode Bandgap Reference Voltage Circuit”, filed on Jul. 16, 2003, which is incorporated by reference herein.

In this embodiment of amplifier circuit 500, folded cascode amplifier 501 includes two p-channel transistors 510 and 511, wherein the gates of p-channel transistor form the input terminal (positive and negative, respectively) of folded cascode amplifier 501. The substrates and sources of p-channel transistors 510 and 511 are connected to a current source 514, which in turn is connected to a voltage source VDDA. The drains of p-channel transistors 510 and 511 are respectively connected to current sources 512 and 513, which in turn are connected to voltage source VSSA.

Folded cascode amplifier 501 further includes p-channel transistors 515 and 516 as well as n-channel transistors 517 and 518. The substrates and sources of p-channel transistors 515 and 516 are connected to voltage source VDDA, whereas the gates of p-channel transistors 515 and 516 are commonly connected. The substrates and sources of n-channel transistors 517 and 518 are connected to the output terminals 519 of folded cascode amplifier 501 (as are the drains of p-channel transistors 510 and 511), whereas the gates of p-channel transistors 515 and 516 are connected to a battery.

In this embodiment of amplifier circuit 500, OTA 503 includes two p-channel transistors 521 and 522 as well as n-channel transistor 523. The substrates and drains of p-channel transistors 521 and 522 are connected to a current source 520, which in turn is connected to voltage source VSSA. The gates of p-channel transistors 521 and 522 form the input terminal to OTA 503. The source of p-channel transistor 521 is connected to voltage source VSSA, whereas the source of p-channel transistor 522 is connected to the drain of n-channel transistor 523. The source and substrate of n-channel transistor 523 are connected to VSSA. The gates of transistors 523 and 507 are commonly connected to the drain of n-channel transistor 523, which provides an output of OTA 503.

The gate of p-channel transistor 505 (which is part of source follower 502) is connected to the source of n-channel transistor 518 (which is part of folded cascode amplifier 510). The drain of p-channel transistor 505 is connected to the output of source follower 502, which can advantageously drive the gate of p-channel transistor 504 using a rail-to-rail voltage.

Exemplary Amplifier Circuit Embodiment

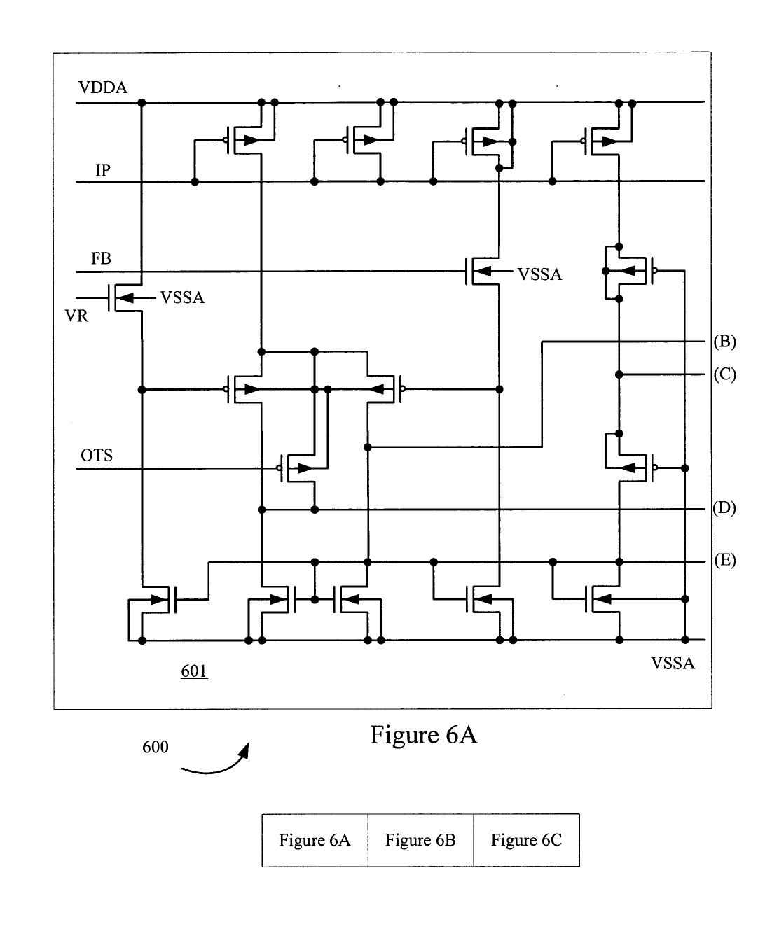

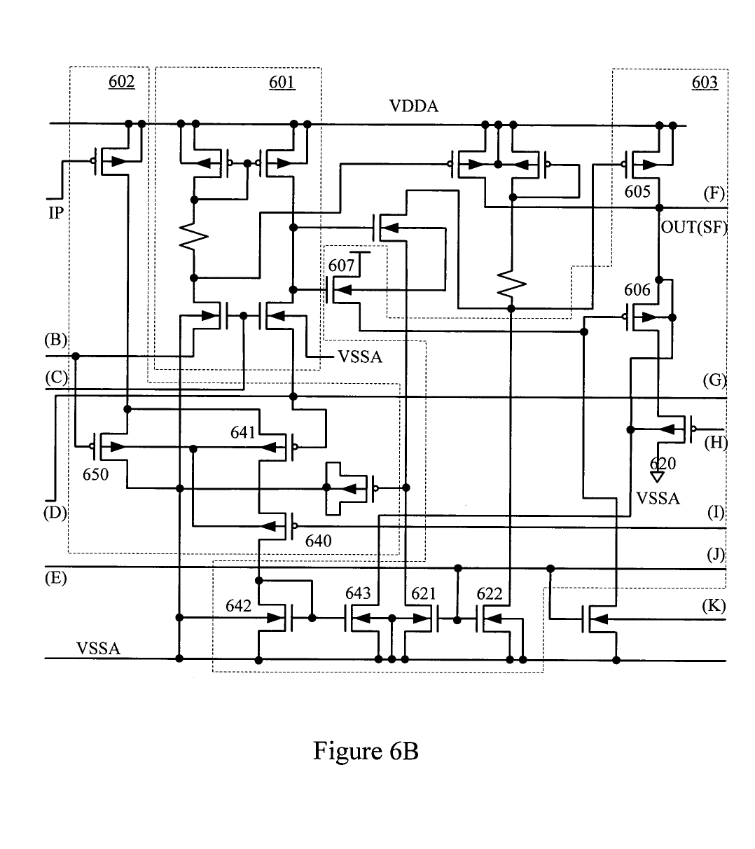

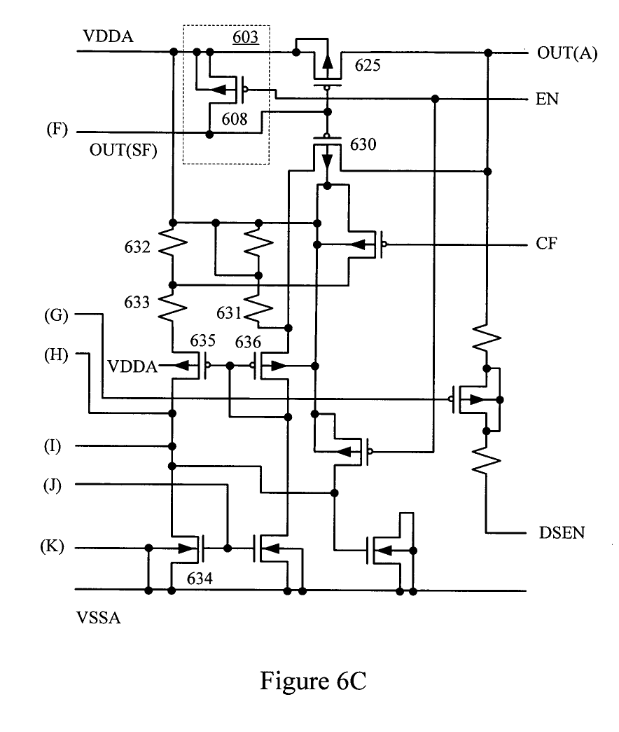

FIGS. 6A-6C illustrate one embodiment of an amplifier circuit 600 in which an exemplary source follower able to provide a rail-to-rail voltage can be incorporated. In this embodiment, amplifier circuit 600 includes a folded cascode amplifier 601, an operational transconductance amplifier (OTA) 602, a source follower 603, and an output device 625.

Source follower 603 can advantageously pull its output terminal OUT(SF) completely to VSSA (e.g. ground). In this embodiment, source follower 603 can include a p-channel transistor 606, which provides an initial pull down to a predetermined level based on its threshold voltage (through p-channel transistor 620, which is conducting during normal operation), and two n-channel transistors 642 and 643, which provide a secondary pull down to the low voltage rail of VSSA.

The voltage on the output terminal OUT(SF) of source follower 603 can subsequently drive output device 625 (in this case, a p-channel transistor). Advantageously, because that voltage can be driven to VSSA by source follower 603, output device 625 can be quite large, thereby optimizing performance of amplifier circuit 600.

In this source follower, a p-channel transistor 605 and p-channel 608 (see FIG. 6C) can provide a current (pull-up) source for p-channel transistor 606. In one embodiment, transistors 605 and 608 can be configured and sized to provide the same current in each branch.

In this embodiment, p-channel transistor 620 can be coupled in series with p-channel transistor 606 to provide an additional path of regulation to the output terminal OUT(SF). Specifically, if either p-channel transistor 620 or p-channel transistor 606 starts to turn off, then the other device can effectively pull the voltage down to VSSA. Note that because p-channel transistor 620 derives its gate signal from a current sensing circuit (see other devices in FIG. 6C), p-channel transistor 620 can operate in either a current sensing mode or a voltage sensing mode.

In amplifier circuit 600, a p-channel transistor 630, which is connected in parallel with output device 625, can be sized to mimic the current through output device 625 at a fraction of the current. In one embodiment, the current through p-channel transistor 630 can be developed across a resistor string including resistor 631. Similarly, the current through an n-channel transistor 634, which serves as a reference device to p-channel transistor 630, can be developed through another resistor string including resistors 632 and 633.

In one embodiment, two p-channel transistors 635 and 636, which are coupled respectively to resistors 633 and 631, can be provided in a current mirror configuration, thereby having the same bias point on their gates. In this configuration, when the sources of the devices are at the same potential, then amplifier circuit 600 is operating under normal conditions and the voltage on the output terminal OUT(SF) can respond to source follower 604.

However, of importance, if a voltage across resistor 631 is greater than a voltage across resistors 632 and 633 (as sensed at the sources of p-channel transistors 635 and 636, then amplifier circuit 600 may be experiencing abnormal conditions. In this case, the voltage on line (H) pulls high, thereby turning off p-channel transistor 620 and disabling p-channel transistor 606. Thus, p-channel transistor 620 can function as a current limiter to p-channel transistor 606.

A p-channel transistor 640 (FIG. 6B) connected to lines (I) and (H) (see FIG. 6C) can provide substantially the same function, i.e. that of a current limiter, for p-channel transistor 641. Specifically, under abnormal conditions, the voltage on line (I) pulls high, thereby turning off p-channel transistor 640 and disabling n-channel transistors 642 and 643. Note that for p-channel transistors 620 and 640, if a current limiter is not invoked, i.e. under normal conditions, then these devices are essentially short circuit switches that are turned on.

P-channel transistors 641 and 650 can sense when amplifier circuit 600 is starting to reach its saturation limit. Once this limit is reached, then current is diverted from these p-channel transistors to n-channel transistors 642 and 643 (through conducting p-channel transistor 640). These n-channel transistors 642 and 643, which sense the higher current and resulting higher voltage on their gates, then begin to conduct. In one embodiment, these n-channel transistors can be sized to multiply the current by 8×.

Therefore, when p-channel transistor 606 cannot pull down the voltage further, n-channel transistors 642 and 643 can efficiently pull the voltage on output terminal OUT(SF) to VSSA. Of importance, because n-channel transistors 642 and 643 are turned on only at the saturation point of amplifier circuit 600, i.e. the same point at which p-channel transistor 606 cannot further pull down the voltage on output terminal OUT(SF), this additional pull down can be performed in a linear manner. This linearity advantageously expands the usefulness of the source follower in linear or amplifying applications.

As mentioned above, under current limiting conditions, p-channel transistor 640 can be turned off, thereby effectively disabling n-channel transistors 642 and 643. This configuration is desirable because even though p-channel transistor 606 may be turning off in response to a current limiting conditions, n-channel transistors 642 and 643 could, i.e. without the presence of p-channel transistor 609, continue to pull the voltage on the output terminal OUT(SF) to VSSA.

In this embodiment of amplifier circuit 600, an n-channel transistor 607 can be used to control whether p-channel transistor 606 conducts. Note that n-channel transistor 607 is in turn controlled by an output from a portion of folded cascode amplifier 601 (note that folded cascode amplifier 601 includes a differential circuit, shown in FIG. 6A, which is coupled through lines (B) and (D) to a current source circuit, shown in FIG. 6B). When a differential input voltage is applied to lines FB (feedback) and VR (voltage reference), the current through lines (B) and (D) is redistributed so as to cause the gate node of n-channel transistor 607 (FIG. 6B) to swing high or low.

Devices that are not labeled provide additional functionalities in amplifier circuit 600. For example, such devices can provide a push-pull drive (which can increase the pull-up current on demand), source follower inputs for level shifting, DC biasing, and additional current limiting. Referring to FIG. 6A, signal IP sets a voltage referenced to VDDA, thereby establishing a current bias for several p-channel transistors receiving signal IP on their gates. Signal FB is the negative input terminal of the amplifier and is connected to a feedback point on the output. Signal VR is the positive input terminal of the amplifier and is connected to a voltage reference (e.g. 1.2 V). Signal OTS (over temperature shutdown) is generated by an OTS circuit, which can disable the output (i.e. drives the output to VSSA) under over temperature conditions.

Although illustrative embodiments of the invention have been described in detail herein with reference to the figures, it is to be understood that the invention is not limited to those precise embodiments. They are not intended to be exhaustive or to limit the invention to the precise forms disclosed. As such, many modifications and variations will be apparent. For example, the source follower described herein could be replaced by an emitter follower implemented in bipolar technology. Accordingly, it is intended that the scope of the invention be defined by the following Claims and their equivalents.

1. A source follower having an input terminal and an output terminal, the source follower comprising:
a first device having first conducting properties connected to the input terminal and the output terminal, the first device further coupled between a first voltage source and a second voltage source;
a current source coupled to the second voltage source, the first device, and the output terminal,
wherein if the first device is not conducting, then the current source pulls a voltage on the output terminal to a voltage provided by the second voltage source, and
wherein if the first device is conducting, then the first device pulls the voltage on the output terminal to a voltage provided by the first voltage source minus a threshold voltage of the first device;
a second device having second conducting properties coupled between the output terminal and the first voltage source,
wherein the second conducting properties are different than the first conducting properties,
wherein the second device receives a different input signal than the first device, and
wherein the second device, when conducting, pulls the voltage on the output terminal to the voltage provided by the first voltage source.

2. The source follower of claim 1, wherein the second device conducts only when the first device provides the voltage provided by the first voltage source minus a threshold voltage of the first device on the output terminal.

3. The source follower of claim 1, wherein the first device includes a p-channel transistor and the second device includes an n-channel transistor.

4. The source follower of claim 3, wherein the first voltage source is a low voltage source and the second voltage source is a high voltage source.

5. The source follower of claim 1, wherein the first device includes an n-channel transistor and the second device includes a p-channel transistor.

6. The source follower of claim 5, wherein the first voltage source is a high voltage source and the second voltage source is a low voltage source.

7. The source follower of claim 1, further including a current limiting control circuit coupled to the first and second devices, wherein the current limiting control circuit disables the first and second devices when the source follower is subjected to abnormal operating conditions.

8. An amplifier circuit providing a rail-to-rail voltage swing, the amplifier circuit comprising:
a source follower having an input terminal and an output terminal, the source follower further including:
a first device having first conducting properties coupled to the input terminal and the output terminal, the first device further coupled between a first voltage source and a second voltage source;
a current source coupled to the first voltage source, the first device, and the output terminal,
wherein if the first device is not conducting, then the current source pulls a voltage on the output terminal to a voltage provided by the second voltage source, and
wherein if the first device is conducting, then the first device pulls the voltage on the output terminal to a voltage provided by the first voltage source minus a threshold voltage of the first device;
a second device having second conducting properties coupled between the output terminal and the first voltage source,
wherein the second conducting properties are different than the first conducting properties,
wherein the second device receives a different input signal than the first device, and
wherein the second device, when conducting, pulls the voltage on the output terminal to the voltage provided by the first voltage source; and
a sensing circuit for triggering the second device to conduct when the amplifier reaches a saturation point.

9. The amplifier of claim 8, wherein the saturation point occurs when the first device provides the voltage provided by the first voltage source minus a threshold voltage of the first device on the output terminal.

10. The amplifier of claim 8, wherein the first device includes a p-channel transistor and the second device includes an n-channel transistor.

11. The amplifier of claim 10, wherein the first voltage source is a low voltage source and the second voltage source is a high voltage source.

12. The amplifier of claim 8, wherein the first device includes an n-channel transistor and the second device includes a p-channel transistor.

13. The amplifier of claim 12, wherein the first voltage source is a high voltage source and the second voltage source is a low voltage source.

14. The amplifier of claim 8, further including a current limiting control circuit coupled to the first and second devices, wherein the current limiting control circuit disables the first and second devices when the amplifier is subjected to abnormal operating conditions.

15. A source follower comprising:
a first transistor having a first channel type, wherein a gate of the first transistor is coupled to an input terminal of the source follower, and wherein a drain of the first transistor is coupled to a first voltage rail;
a current source coupled between a source of the first transistor and a second voltage rail; and
a second transistor having a second channel type different than the first channel type, wherein a gate of the second transistor receives a signal triggered by a limit associated with the first transistor, wherein a source of the second transistor is coupled to the first voltage rail, and wherein a drain of the second transistor is coupled to the source of the first transistor and an output terminal of the source follower.

16. The source follower of claim 15, wherein the source follower forms part of an amplifier, and wherein a portion of the amplifier generates the signal triggered by the limit associated with the first transistor.

17. The source follower of claim 16, wherein the limit associated with the first transistor includes a threshold voltage.

18. The source follower of claim 16, wherein the limit associated with the first transistor occurs at a saturation point of the amplifier.

19. A system for providing a rail-to-rail voltage, the system comprising:
means for driving an output voltage of the system to a first predetermined voltage, which is less than a first rail voltage; and
means for driving the output voltage of the system to the first rail voltage after sensing the first predetermined voltage.

20. The system of claim 19, further including means for driving the output voltage of the system to a second rail voltage.

21. A method for providing a rail-to-rail voltage, the method comprising:
driving an output voltage of a system to a first predetermined voltage, which is less than a first rail voltage; and
after sensing the first predetermined voltage, driving the output voltage of the system to the first rail voltage.

22. The method of claim 21, further including driving the output voltage of the system to a second rail voltage.

23. An amplifier circuit providing a rail-to-rail voltage, the amplifier circuit comprising:
a folded cascode amplifier;
an operational transconductance amplifier (OTA);
a source follower including:
a primary device for driving an output voltage near a first voltage rail, wherein the primary device receives an output of the folded cascode amplifier; and
a secondary device for driving the output voltage to the first voltage rail when the primary device reaches its limit, wherein the secondary device receives an output of the OTA; and
a current source for driving the output voltage to a second voltage rail when the primary and secondary devices are not conducting.
